(19) United States
(12) Patent Application Publication
(10) Pub. No.: US 2022/0009081 A1
(43) Pub. Date: Jan. 13, 2022

(54) ROBOT UNIT HAVING ROTATABLE ARMS

(71) Applicant: SIEMENS AKTIENGESELLSCHAFT, München (DE)

(72) Inventor: Nicola Maria Ceriani, Erlangen (DE)

(21) Appl. No.: 17/294,035

(22) PCT Filed: Nov. 15, 2018
(86) PCT No.: PCT/EP2018/081418

§ 371 Date: May 14, 2021

(51) Int. Cl. B25J 9/00; B25J 9/10; B25J 17/02

(52) U.S. Cl. CPC B25J 9/0051; B25J 17/0266; B25J 9/108; B25J 9/106

(57) ABSTRACT

The invention relates to a robot unit (1) having—a base (2),—an effector unit (8),—at least two connecting arms (3) 1:7 for connecting the base and the effector unit (8), and—a base motor (10) for each of the at least two connecting arms (3) in order to move the respective connecting arms relative to the base, wherein—a first arm part (4) of each of the at least two connecting arms (3) is arranged on the base (2) and a second arm part (5) of each of the at least two connecting arms (3) is arranged on the effector unit (8), and wherein—each first arm part (4) and its associated second arm part (5) are movably connected to each other by a connecting N element (13). In order to allow improved movability for the effector unit (8), according to the invention,—the at least two connecting arms (3) each have a pivot bearing (15), wherein the pivot bearings (15) each allow rotation of at least one component (7) of the arm parts (4, 5) about an axis of rotation (20) oriented parallel to its direction of extension.

### CROSS REFERENCE TO RELATED APPLICATIONS

This present patent document is a § 371 nationalization of PCT Application Serial Number PCT/EP2018/081418 filed on Nov. 15, 2018, designating the United States, which is hereby incorporated in its entirety by reference.

### FIELD

Embodiments relate to a robot unit and a so-called parallel arm robot or Delta robot.

### BACKGROUND

Robot units are used for various activities, for example on an industrial scale. For handling tasks, parallel arm robots or Delta robots are commonly used. Handling tasks are partly known also as “pick-and-place” applications. Examples of these are placing components on a workpiece on a production line, or arranging or stacking products in a packaging.

Parallel arm robots are described as parallel since several connecting arms are arranged in parallel between a base of the parallel arm robot and an effector unit. “Parallel” here generally does not mean that the connecting arms run geometrically parallel. Instead, “parallel” describes the property that the connecting arms are each arranged between the same components of the robot unit, namely the base and the effector unit, for example each in a similar fashion. This for example should be understood as distinct from a robot arm with several arms arranged in series.

A tool suitable for a respective task may be arranged on the effector unit, also known as the effector. For example, the effector unit has a corresponding fixing unit for arrangement of a tool.

Parallel arm robots may be used particularly effectively for handling tasks, since they may allow a high speed and may therefore perform a comparatively high number of work steps (picks) per time unit.

Generic arrangements with parallel arm solutions are known from DE 10 2015 115 965 A1 and JP 2013 052499A.

Disadvantages of parallel arm robots are the restricted movement sequences because of their structure.

### BRIEF SUMMARY AND DESCRIPTION

The scope of the present invention is defined solely by the appended claims and is not affected to any degree by the statements within this summary. The present embodiments may obviate one or more of the drawbacks or limitations in the related art.

Embodiments an improved mobility for an effector unit of robot unit.

In an embodiment, a robot unit is provided that includes a base, an effector unit, at least two connecting arms for connecting the base and the effector unit, and a base motor for each of the at least two connecting arms, for moving the respective connecting arm relative to the base. A first part arm of each of the at least two connecting arms is arranged on the base, and a second part arm of each of the at least two connecting arms is arranged on the effector unit. The respective first part arm and the respective second part arm are movably connected together by a connecting element.

In order to provide improved mobility of the effector unit, the at least two connecting arms each include a pivot bearing. The pivot bearings each provide rotation of at least one component of the part arms about a rotation axis that is oriented parallel to its extent direction.

The base may be a part of the robot unit that, in normal operation of the robot unit, is fixedly arranged on a superior component of a plant. The robot unit performs working steps by moving the effector unit relative to the base. For a handling task, it is for example provided that a control or movement of the effector unit is provided between a start position and a destination position for the components to be moved. A fixing unit may be arranged on the effector unit that allows arrangement of a tool by the effector unit. In principle, here all conceivable tools are possible, for example tools for material machining (e.g., drill), forming (e.g., extruder of a 3-D printer), or material movement (e.g., gripper). For handling tasks, for example tools for material movement, for example grippers, may be arranged on the effector unit.

A relative movement between the base and the effector unit may be controlled or carried out by a movement of at least two connecting arms. For example, the movement or position of the at least two connecting arms relative to the base is controlled by the respective base motors. In other words, the respective base motors are configured for positioning or moving the at least two connecting arms. By positioning or moving the least two connecting arms, the respective base motors may indirectly influence the relative position between the base and the effector unit.

The at least two connecting arms each include a respective first and second part arm. The at least two connecting arms may in addition include further part arms. The connecting arms may alternatively consist exclusively of the first and second part arms. The second part arms may each be arranged on the effector unit by a respective rotation bearing. The respective rotation bearings may each include precisely two degrees of freedom. The first part arms may each be arranged on the base by a respective rotation bearing. The respective rotation bearings may each include precisely one degree of freedom. The first part arm and the second part arm of a respective connecting arm are connected together via the connecting element. The connecting elements may be a respective hinge or a respective rotation bearing. The connecting elements may each include precisely one or preferably precisely two degrees of freedom.

The respective pivot bearings allow the part arms to rotate at least partially about the rotation axis. For example, the pivot bearings allow a self-rotation of the respective part arms. For example, the pivot bearings allow rotation of the respective first part arm or respective second part arm. The pivot bearings or the rotation of the respective part arms allow a rotary movement of the effector unit. For example, the effector unit may be tilted or inclined relative to the base by a corresponding rotary movement of all part arms. This allows improved mobility of the effector unit relative to the base.

All connecting arms of the robot unit may be identical. In other words, all connecting arms of the robot unit may include the same technical structure. In this case, for example the only difference between the different connecting arms is their positioning on the base and the effector unit. For example, the connecting arms are each arranged at a constant angle with respect to the base. In the case of three connecting arms, these are for example each arranged on the base rotated through 120°.

According to a refinement, it is provided that the first part arms are arranged rotatably on the base via a respective rotation bearing. In other words, the first part arms are arranged rotatably on the base. For example, a respective part arm may include precisely one respective degree of freedom relative to the base because of the rotation bearing. In this way, an advantageous control of the robot unit may be achieved.

According to a refinement, it is provided that the first and the second part arms of a respective one of the least two connecting arms are pivotable relative to one another, for example exclusively, via the respective connecting element. In other words, the first and the second part arms of a respective connecting arm exclusively rotate relative to one another. A translational relative movement may thus be prevented by the respective connecting element. For example, the first and second part arms of a respective connecting arm may be pivotable relative to one another exclusively with respect to precisely one degree of freedom, or with respect to precisely two degrees of freedom. The precisely two degrees of freedom may each be a relative rotation with respect to precisely two independent spatial angles. In this way, a particularly advantageous mobility of the robot unit may be achieved.

According to a refinement, it is provided that the at least two connecting arms each include at least one arm motor for performing the rotation of the at least one component. The arm motors may be arranged on the respective connecting arms. The arm motors may actuate a respective degree of freedom of the robot unit. For example, the arm motors actuate the rotation of the at least one component of the respective part arm. In this way, new additional degrees of freedom may be controllable via the pivot bearings.

According to a refinement, it is provided that the arm motors are arranged in the interior of the respective first or second part arm. In other words, the arm motor of a respective connecting arm may be enclosed fully or partially by the first or second part arm of the corresponding connecting arm. For example, the respective part arm may for this include a cavity in which the respective arm motor is arranged. In this way, the arm motors may be arranged particularly compactly and reliably on the robot unit. Also, with this form of arrangement, a moment of inertia of the connecting arms may be kept low, that benefits a working speed of the robot unit.

According to various embodiments, it may be provided that the first part arms and/or the second part arms rotate in themselves.

Accordingly, it is provided for example that the first part arms are each divided into two members, and the pivot bearings allow a rotation of a respective one of the members relative to the other of the members as a rotation of the component of the part arms. For example, a first of the members may be fixed on the base by the respective rotation bearing of the corresponding part arm.

In an embodiment, the second part arms are each divided into two members, and the pivot bearings allow a rotation of a respective one of the members relative to the other of the members as a rotation of the component of the part arms. For example, the first member is arranged on the first part arm by the respective connecting element, and the second member may be mounted rotatably relative to the first member by the pivot bearing.

In the above-mentioned embodiments, in each case a respective one of the members constitutes the respective part arm component whose rotation is enabled by the respective pivot bearing. For example, each of the first/second part arms is divided into two members. For each of the first/second part arms, a respective pivot bearing allows the rotation of a respective one of the members relative to the other of the members. For example, the two members in each case are connected together exclusively via the pivot bearing. For example, one of the members is mounted rotatably in the pivot bearing that is fixedly arranged on the other member.

According to a refinement, it is provided that the arm motors are each arranged on a first of the members and connected to a second of the members via a shaft along the extent direction of the respective part arm. In other words, the respective arm motor of a part arm may be arranged on the first of the members. For example, the respective arm motor is arranged on a side of the first member facing away from the second member. The respective shaft may then be guided to the second member from the arm motor or from the side facing away from the second member. In this way, a positioning of the arm motor as close as possible to the base may be guaranteed, that reduces the moment of inertia.

For example, it may be provided that the shafts are each guided through the first member, for example through a tunnel of the respective first member. For example, for this the first members form the tunnel for the respective shaft. For example, the respective shaft may be guided through the tunnel to the second member from the arm motor or from the side of the first member facing away from the second member. In this way, a particularly compact form may be achieved.

According to a refinement, it is provided that the pivot bearings are each formed by one of the two members. In other words, the respective pivot bearing of one of the part arms may be formed by the respective first member. For example, the respective pivot bearing is formed by the respective tunnel of the first member. In this way, an even more compact form may be achieved.

According to a refinement, it is provided that a respective rotation axis of the pivot bearings is oriented parallel to a main extent direction of the members of the respective part arm. In general, the respective rotation axis of the at least one component of the part arms may run parallel to the extent direction. For example, the rotation axis of the pivot bearings, or the rotation of the members, runs parallel to the first and/or second member. In this way, a particularly compact geometric structure of the robot unit is achieved.

According to a refinement, it is provided that the members of a respective part arm are connected at a straight angle (180°) via the pivot bearing. This applies for example for a respective main extent direction of the members of a respective part arm. The first member and the second member of a respective part arm may run parallel to one another, for example with respect to the direction. Also, the second member may directly adjoin the first member. In other words, the second member may be a straight extension of the first member. As already stated, the second member may be at least partially surrounded by the first member. In this case, the first member may form the pivot bearing for the second member. In this way, an even more compact structure may be obtained.

According to a refinement, the robot unit includes a control unit that is configured to control a rotation of the respective first part arm or respective second part arm such that an angle between the base and the effector unit is changed. For example, to this end, the control unit is configured to actuate the arm motors and/or the base motors. By actuating the arm motors and/or base motors, a corresponding movement of the connecting arms may be provoked. The movement of the connecting arms then leads to a corresponding movement of the effector unit. In this way, by the control unit, the position of the effector unit relative to the base may be changed. For example, the effector unit may be inclined relative to the base.

According to a refinement, it is provided that the robot unit has precisely three connecting arms. For example, the three connecting arms are configured identically. The three connecting arms may correspond to the above-mentioned at least two connecting arms. The three connecting arms may each be arranged on the base with an angular spacing of 120°. Three connecting arms have proved to be a particularly successful compromise for the robot unit.

According to a refinement, it is provided that the robot unit has precisely six actuated or motorized degrees of freedom. For example, this is advantageous if the robot unit has precisely three connecting arms. The six actuated degrees of freedom may then be divided over the three arm motors and the three base motors of the three connecting arms. In this way, the three connecting arms may be driven particularly usefully.

### BRIEF DESCRIPTION OF THE FIGURES

FIG. 1 depicts a schematic, perspective view of an embodiment of a robot unit.

FIG. 2 depicts a schematic, exploded view of a part arm of an embodiment of the robot unit.

FIG. 3 depicts a schematic overview of the rotation axes of an embodiment of the robot unit.

FIG. 4 depicts a schematic overview of degrees of freedom of an effector unit of an embodiment of the robot unit.

FIG. 5 depicts a schematic, exploded view of a part arm of the robot unit according to an embodiment.

### DETAILED DESCRIPTION

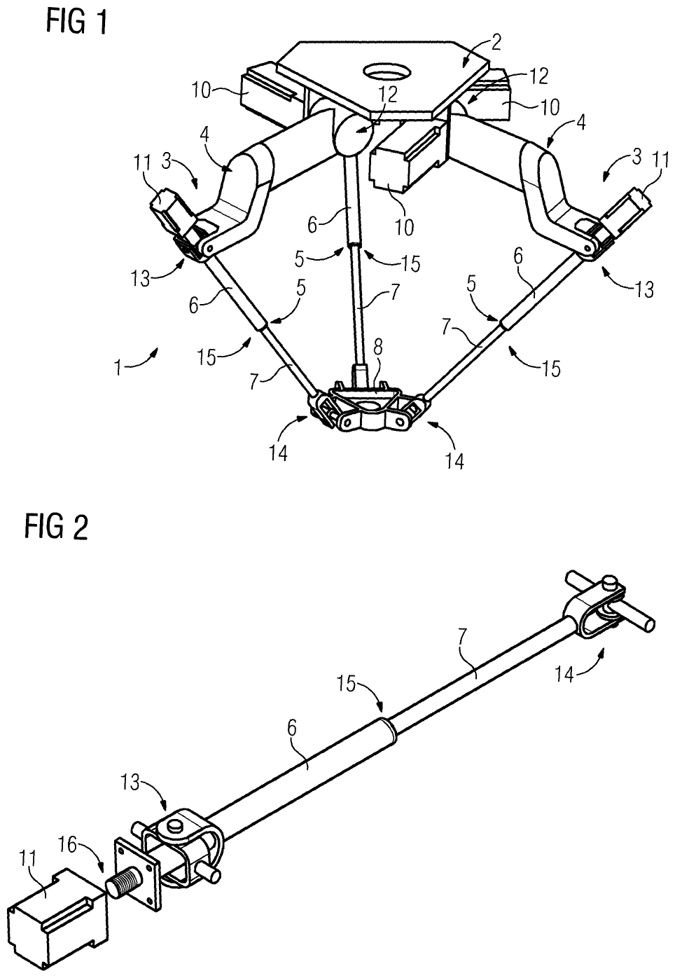

FIGS. 1, 3 and 4 each depict a robot unit 1 in different embodiments. The robot unit 1 includes a base 2 on which three connecting arms 3 are arranged. The connecting arms 3 are each arranged on the base 2 rotated through 120°. The connecting arms 3 each include a first part arm 4 and a second part arm 5. The first part arms 4 are rotatably mounted on the base 2 via a respective rotation bearing 12. The first part arm 4 and the second part arm 5 of each connecting arm 3 are connected together via a respective connecting element 13. The second part arms 5 are rotatably mounted on an effector unit 8 via a respective rotation bearing 14. Since the connecting arms 3 are arranged in similar fashion between the base 2 and the effector unit 8, the robot unit 1 is also known as a parallel arm robot or a so-called Delta robot. The effector unit 8, also known as an effector, includes a tool carrier (not shown in detail in the figures), by which a tool, for example a gripper, may be arranged on the effector unit 8.

The first part arms 4 are each part arms that are arranged directly on the base 2. The second part arms 5 are each part arms that are further away from the base 2. The part arms 5 are thus arranged between the first part arms 4 and the effector unit 8.

The first part arms 4 are mounted so as to be rotatable or pivotable relative to the base 2 about a respective, precisely one rotation axis 21. In other words, a movement of the part arms 4 may take place only in a respective plane and rotationally about the respective rotation bearing 12. In yet other words, for each of the part arms 4 relative to the base 2, of six degrees of freedom (three translational, three rotational), all except one rotational degree of freedom are blocked by the respective rotation bearing 12.

The second part arms 5 are mounted so as to be rotatable or pivotable relative to the respective first part arm 4 of the same connecting arm 3 with respect to precisely two rotation axes. In other words, a movement of the second part arms 5 relative to the respective part arm 4 may take place only along a respective ball sphere and only rotationally about the respective connecting element 13. In yet other words, for each of the second part arms 5 relative to the respective part arm 4, of six degrees of freedom (three translational, three rotational), all except two rotational degrees of freedom are blocked by the respective connecting element 13.

The second part arms 5 are arranged on the effector unit 8 by a respective rotation bearing 14. The second part arms 5 are mounted so as to be rotatable or pivotable relative to the effector unit 8 with respect to precisely two rotation axes. In other words, a movement of the second part arms 5 relative to the effector unit 8 may take place only along a respective ball sphere and only rotationally about the respective rotation bearing 14. In yet other words, for each of the second part arms 5 relative to the effector unit 8, of six degrees of freedom (three translational, three rotational), all except two rotational degrees of freedom are blocked by the respective rotation bearing 14.

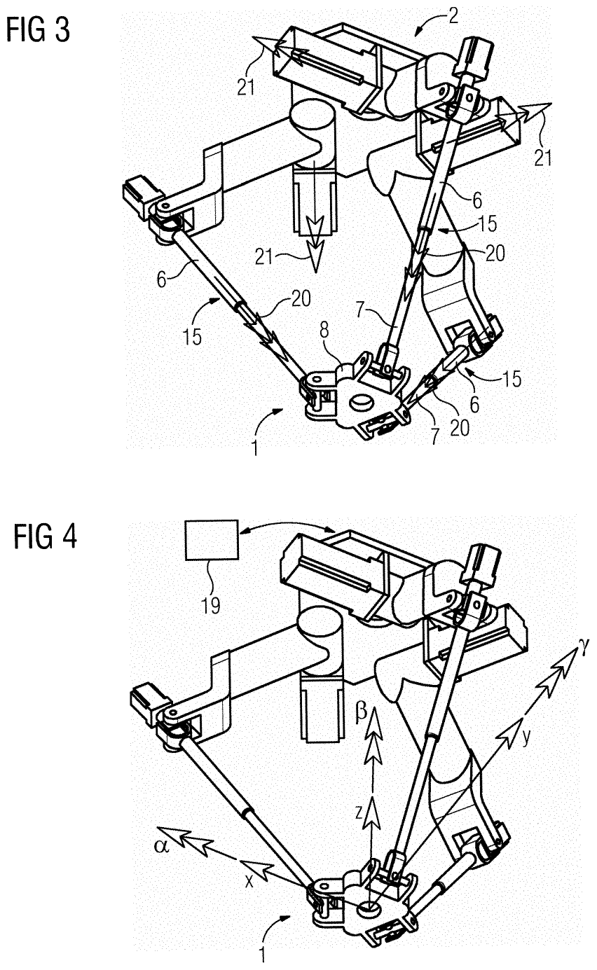

By corresponding movement of the connecting arms 3, a movement of the effector unit 8 is possible. For this, the robot unit 1 has a respective base motor 10 for each of the connecting arms 3. In an embodiment, the base motor 10 is arranged on the base. The respective base motors 10 allow a movement of the connecting arms 3 or part arms 4 in relation to the respective rotation axis 21. The rotation axes 21 are shown in FIG. 3.

In addition, in the embodiment of the robot unit 1, individual part arms 4, 5 are rotatable in themselves. For this, each of the part arms 4, 5 of a respective connecting arm 3 has a respective pivot bearing 15.

According to the embodiment of FIGS. 1 to 4, the second part arms 5 of each of the connecting arms 3 are divided into two members 6, 7. This embodiment will be discussed initially: such a second part arm 5 is shown in a schematic exploded illustration in FIG. 2. A first member 6 includes a part of the connecting arm 13 for connection to the respective first part arm 4. A second member 7 includes a part of the rotation bearing 14 for connection to the effector unit 8. In other words, in mounted state, the first member 6 is arranged on the first part arm 4. However, in mounted state, the second member 7 is arranged on the effector unit 8.

In the present case, the first member 6 forms the pivot bearing 15. The first member 6 is configured to be partially hollow. This creates a tunnel in the middle of the first member 6. The second member 7 is partly inserted in this tunnel. Thus, the pivot bearing 15 is provided by this tunnel. A shaft 16 is guided through the tunnel through the first member 6. The shaft 16 connects an arm motor 11 to the second member 7. The arm motor 11 is arranged on a side of the first member 6 facing away from the second member 7. In other words, the arm motor 11 and the second member 7 are substantially spaced apart from each other by the first member 6.

The pivot bearing 15 provides a further degree of freedom for each connecting arm 3. These degrees of freedom are actuated or controlled by the respective arm motor 11. In each case, the pivot bearing 15 provides a rotational degree of freedom along a rotation axis 20 (see FIG. 3). A translational movement of the first member 6 and second member 7 relative to each other may be suppressed by the pivot bearing 15. The rotation about the rotation axis 20 is actuated or controlled by the respective arm motor 11 arranged on the first member 6.

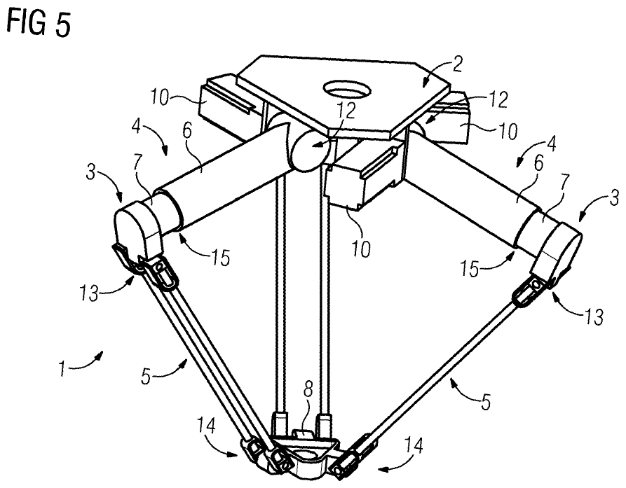

A first part arm 4 is shown in a schematic exploded illustration in FIG. 5. A first member 6 includes a part of the rotation bearing 12 for connection to the base 2. A second member 7 includes a part of the connecting element 13 for connection to the respective second part arm 5 of the respective connecting arm 3. In other words, in mounted state, the first member 6 is arranged on the base 2. However, in mounted state, the second member 7 is arranged on the connecting element 13 or on the second part arm 5.

In the present case, the first member 6 forms the pivot bearing 15. The first member 6 is configured to be partially hollow. This creates a tunnel 22 in the middle of the first member 6. The second member 7 is partially inserted in this tunnel 22. Thus, the tunnel 22 provides the pivot bearing 15. In addition, an arm motor 11 is arranged in this tunnel 22. The arm motor 11 may be arranged directly on the second member 7. For example, the arm motor 11 is connected to the second member 7 via a shaft 16.

The pivot bearing 15 provides a further degree of freedom per connecting arm 3. These degrees of freedom are actuated or controlled by the respective arm motor 11. In each case, the pivot bearing 15 provides a rotational degree of freedom along a rotation axis 20. A translational movement of the first member 6 and second member 7 relative to one another may be suppressed by the pivot bearing 15. The rotation about the rotation axis 20 is actuated or controlled by the respective arm motor 11 arranged on the first member 6.

FIG. 4 depicts the respective degrees of freedom x, y, z, α, β, γ of the effector unit 8. These differ only insignificantly between the embodiments. The six degrees of freedom along the rotation axes 20 and 21 allow a movement of the effector unit 8 along all six possible degrees of freedom x, y, z, α, β, γ(three translational, three rotational). By corresponding control of the arm motors 11 and base motors 10, a movement of the effector unit 8 along all six degrees of freedom x, y, z, α, β, γ is possible. The robot unit 1 may include a control unit 90 that is configured for such control.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A robot unit comprising:
a base;
an effector unit;
at least two connecting arms configured to connect the base and the effector unit; and
a base motor for each of the at least two connecting arms, the base motor configured to move the respective connecting arm relative to the base;
wherein a first part arm of each of the at least two connecting arms is arranged on the base, and a second part arm of each of the at least two connecting arms is arranged on the effector unit;
wherein the respective first part arm and the respective second part arm are movably connected together by a connecting element;
wherein the at least two connecting arms each have a pivot bearing,
wherein the pivot bearings each allow rotation of at least one component of the part arms about a rotation axis that is oriented parallel to its extent direction;
wherein the second part arms are each divided into two members, and the pivot bearings allow a rotation of a respective one of the members relative to the other of the members as a rotation of the at least one component of the part arms.

2. The robot unit of claim 1, wherein the first part arms are each arranged rotatably on the base via a respective rotation bearing.

3. The robot unit of claim 1, wherein the first and the second part arms of a respective one of the at least two connecting arms are pivotable relative to one another, via the respective connecting element.

4. The robot unit of claim 1, wherein the at least two connecting arms each have at least one arm motor configured to perform the rotation of the at least one component.

5. The robot unit of claim 4, wherein the arm motors are arranged in an interior of a respective first part arm or second part arm.

6. The robot unit of claim 4, wherein the first part arms are each divided into two members and the pivot bearings are configured to provide a rotation of a respective one of the members relative to the other of the members as a rotation of the at least one component of the first part arms.

7. (canceled)

8. The robot unit of claim 6, the arm motors are each arranged on a first of the members and connected to a second of the members via a shaft along the extent direction of the respective part arm.

9. The robot unit of claim 8, wherein the shafts are guided through a tunnel of the respective first member.

10. The robot unit of claim 6, wherein the pivot bearings are each formed by one of the two members.

11. The robot unit of claim 6, wherein a respective rotation axis of the pivot bearings is oriented parallel to a main extent direction of the members of the respective part arm.

12. The robot unit of claim 6, wherein the members of a respective part arm are connected at a straight angle by the pivot bearing.

13. The robot unit of claim 1, further comprising: a control unit configured to control a rotation of the respective first part arm or respective second part arm such that an angle between the base and the effector unit is changed.

14. The robot unit of claim 1, wherein the robot unit comprises precisely three connecting arms.

15. The robot unit of claim 1, wherein the robot unit comprises precisely six actuated degrees of freedom.
